(19) United States
(12) Patent Application Publication
(10) Pub. No.: US 2016/0174475 A1
(43) Pub. Date: Jun. 23, 2016

(54) Indiscriminately On-the-GO Tree Heat Treatment Apparatus and its Effective Methods

(71) Applicant: Ali Mirzakhani Nafchi, Lake Alfred, FL (US)

(72) Inventor: Ali Mirzakhani Nafchi, Lake Alfred, FL (US)

(21) Appl. No.: 14/953,417

(22) Filed: Nov. 29, 2015

Related U.S. Application Data
(63) Continuation of application No. 62/123,851, filed on Dec. 1, 2014.

(51) Int. Cl. A01G 23/00; A01G 1/00; A01G 7/04

(52) U.S. Cl. CPC A01G 23/00; A01G 7/04; A01G 1/001

(57) ABSTRACT

Presently, there is a willing to reduce the chemicals and not using the systematic chemical control especially in organic farming. Using of heat treatment method to eliminate the pathogen is an old method but there was no devices to address the needs of those attempting to control of pathogen effectively. The present invention is comprising but not limited to; structural design, heating system, system to reduce transpiration, system and method to maintain the uniformity of temperature and humidity, method/s to control the heat transfer rate into trees tissue and system to maintain the heat transfer duration, more particularly, the present invention is to;
Increase the uniformity and faster penetration into tree canopy middle
Reduce the energy consumption by targeting the tree canopy
Reduce the time of operation and increase the quality of the treatment
Reduce the risk of operation due to increase the uniformity and also, by providing variable rate heat transfer to the tree as per requirement

Optionally, by attaching the roots heat treatment machine to the tree heat treatment apparatus, all the canopy will be covered in one pass.

### STATEMENT OF NOT FUNDED OR GRANTED BY FEDERAL FUND

Hereby, it is declare that, the present disclosure has not supported with federal money or grant.

### BACKGROUND OF THE INVENTION

The invention relates to the field of improving method of heat treatment to combat diseases; more particularly a method/s for tree diseases control and reduce the destructive effects of diseases and increase the efficiency. Heat treatment of plants has shown promising scope to eliminate some pathogens in crops.

Lin et al. 1964 reported eliminating yellow shoot disease by water-saturated hot air treatment of graft wood at 48-58° C. with no loss of tissue viability.

Cheema et al. 1982, reported treatment of budwood at 47° C. for 2 h reduced disease incidence and longer treatments eliminated the pathogen.

Lo et al. 1981, further proved that diseased budlings recovered normal growth after moist air treatment for 50 min at 49° C. or 50° C. Lo 1983, reported that budwoods collected from diseased tree could be sterilized by immersing in 47° C. water for 10 min and repeat twice with the interval of 24 hours.

### BRIEF DESCRIPTION OF THE DRAWINGS

The ingenious “Indiscriminately On-the-GO Tree Heat Treatment Apparatus and its Effective Methods”, with high penetration into canopy and optimum uniformity as per requirement, is shown in FIGS. 1 to 12 including;

FIG. 1 is the front view of an “Indiscriminately On-the-GO Tree Heat Treatment Apparatus” to apply the invented effective methods;

FIG. 2 is the right view of the “Indiscriminately On-the-GO Tree Heat Treatment Apparatus” and effective methods, with extended tail chamber including some of the components;

FIG. 3 is a cross section of the right view of the “Indiscriminately On-the-GO Tree Heat Treatment Apparatus”, without extended tail chamber including the components;

FIG. 4 is the bottom view of the “Indiscriminately On-the-GO Tree Heat Treatment Apparatus”, without extended tail chamber including the components;

FIG. 5 is the perspective front-left view of the “Indiscriminately On-the-GO Tree Heat Treatment Apparatus”, with extended tail chamber including some components;

FIG. 6 is the perspective top-left view of the “Indiscriminately On-the-GO Tree Heat Treatment Apparatus”, with assembled tail chamber.

FIG. 7 is a cross section; ‘right side’, of the front view of the “Indiscriminately On-the-GO Tree Heat Treatment Apparatus”.

FIG. 8 is a cross section; ‘left side’, of the front view of the “Indiscriminately On-the-GO Tree Heat Treatment Apparatus”, with transportation mood of tail chamber;

FIG. 9 is the perspective; front-left view of a schematic operation mood of the “Indiscriminately On-the-GO Tree Heat Treatment Apparatus”, to apply the invented treatment methods;

FIG. 10 is the front view of the invented “Indiscriminately On-the-GO Tree Heat Treatment Apparatus”, attached with the tail chamber, all in transportation mood;

FIG. 11 is the top view of the steam injector, to inject steam into soil for orchards in operation mood and,

FIG. 12 is the right view of the steam injector apparatus in operation mood.

### DETAILED DESCRIPTION

(Notice: In this section, sometimes, the word ‘apparatus’ used as brief form of “Indiscriminately On-the-GO Tree Heat Treatment Apparatus”) The Indiscriminately On-the-GO Tree Heat Treatment Apparatus and its Effective Methods, is related to perform heat treatment in one pass for tree canopy and the tree root system as well. By attaching the roots heat treatment machine to the Indiscriminately On-the-Go Tree Heat Treatment Apparatus, it is possible, if two tasks needed to be done at once, although it is possible to use these two device separately.

The present disclosure, describes various embodiments for systems, devices, and methods for reducing energy consumption comprising an “Indiscriminately On-the-GO Tree Heat Treatment Apparatus” to perform the methods. These methods are to eliminate or reduce tree infections level, infected by diseases like HLB, using effective methods.

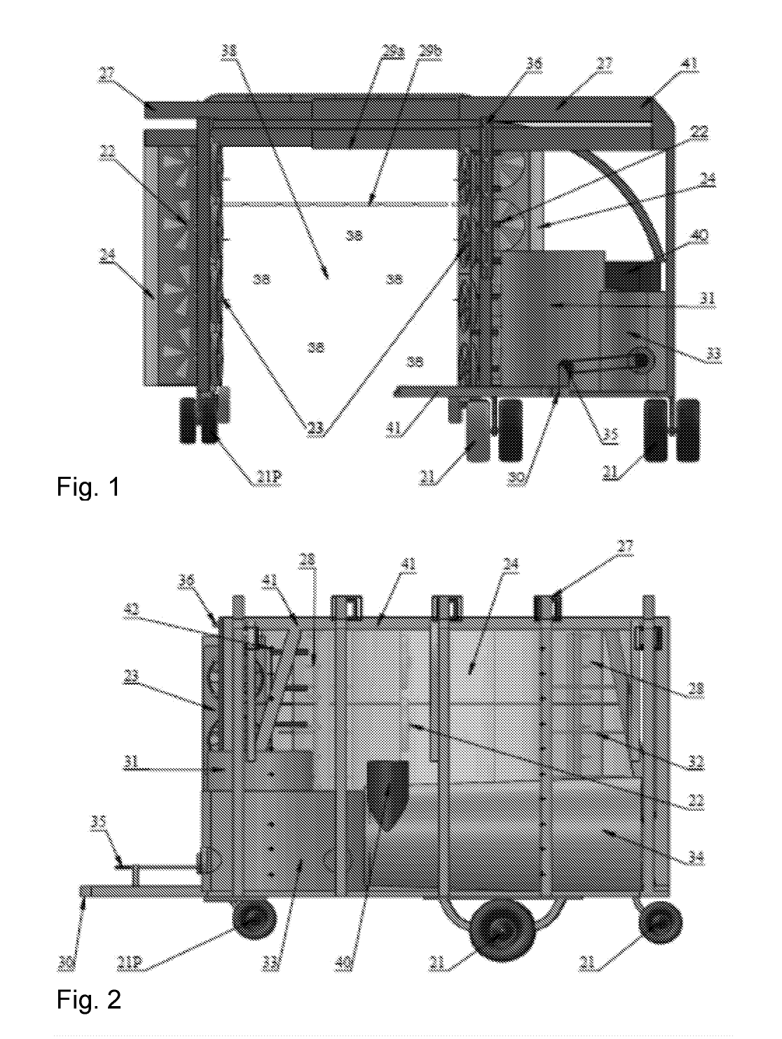

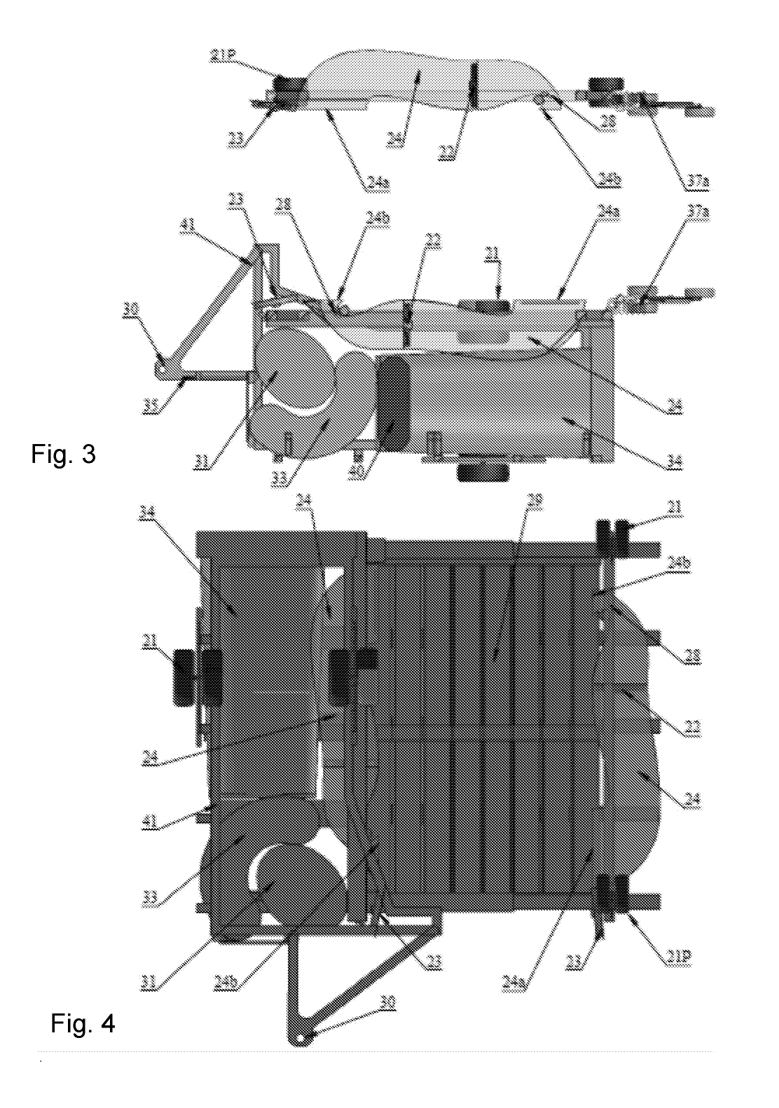

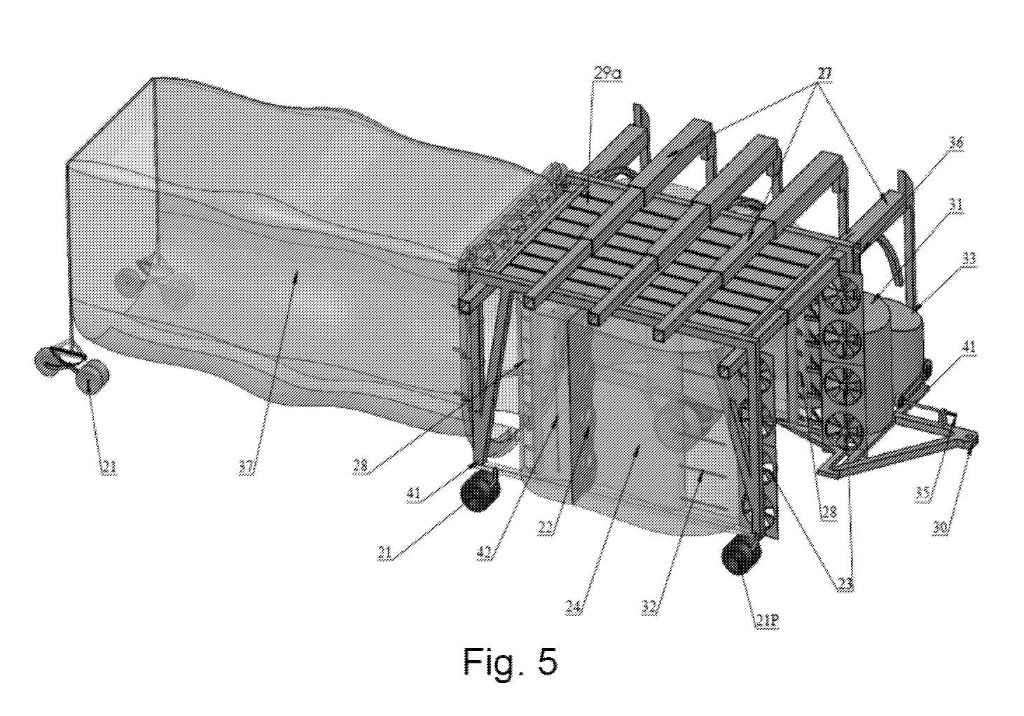

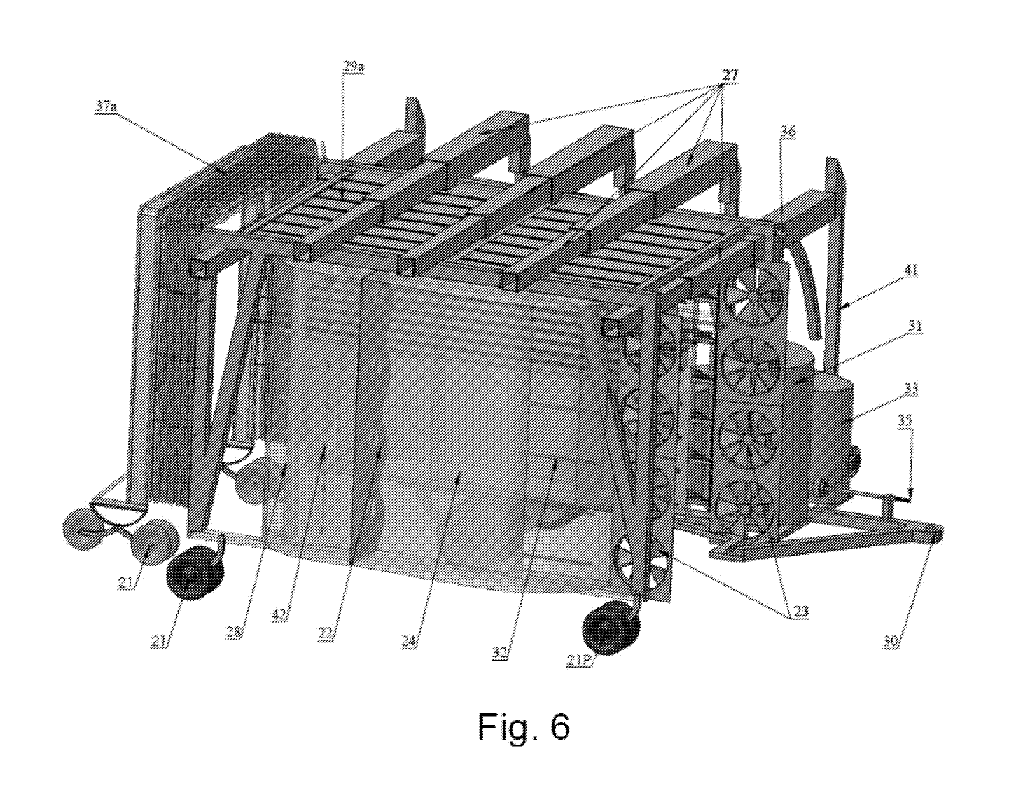

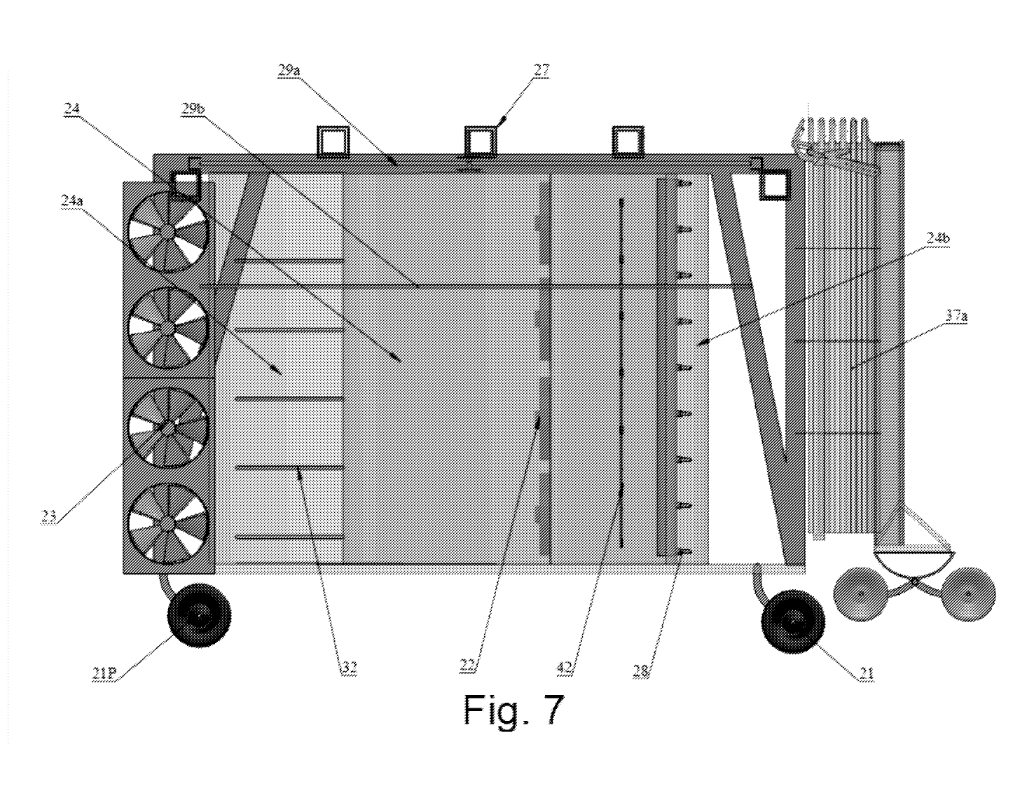

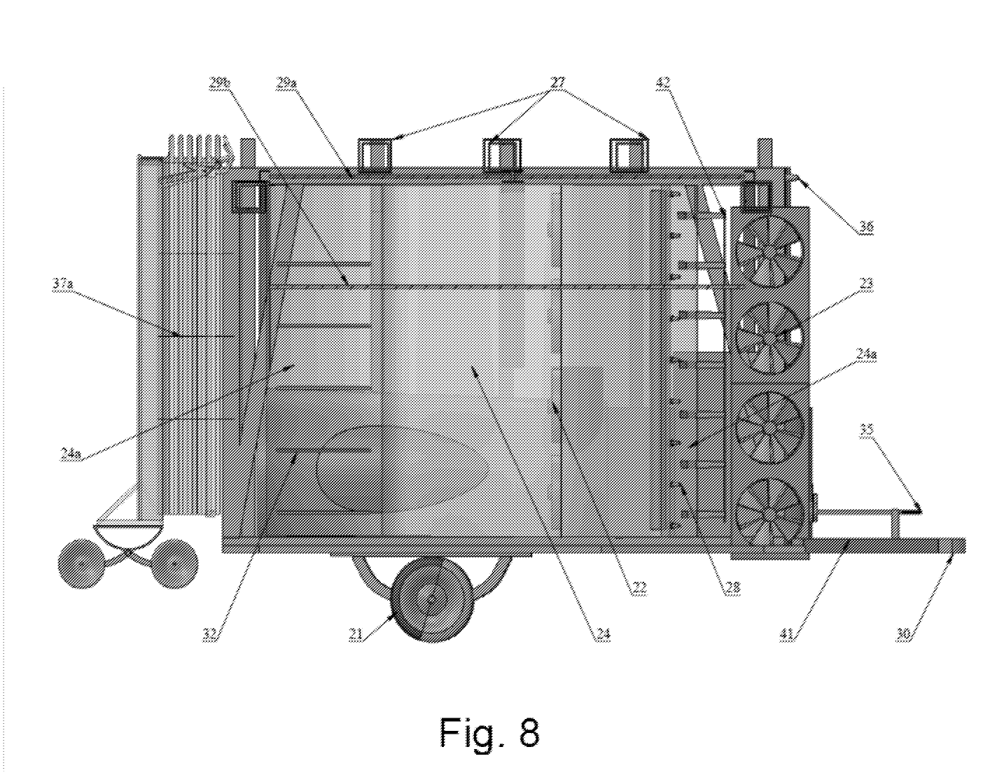

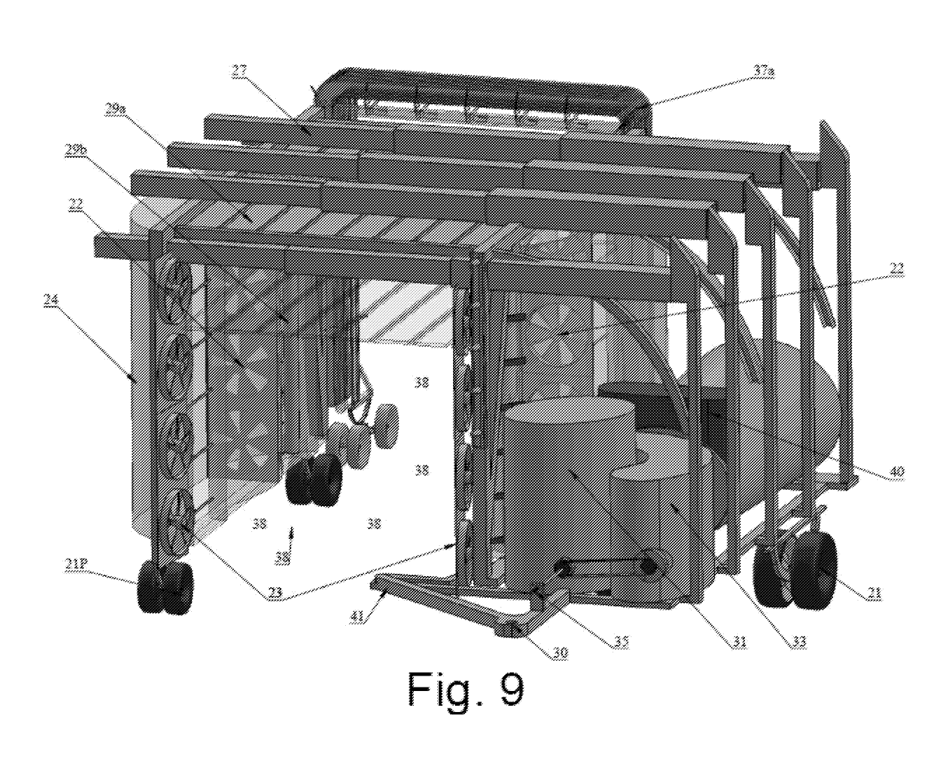

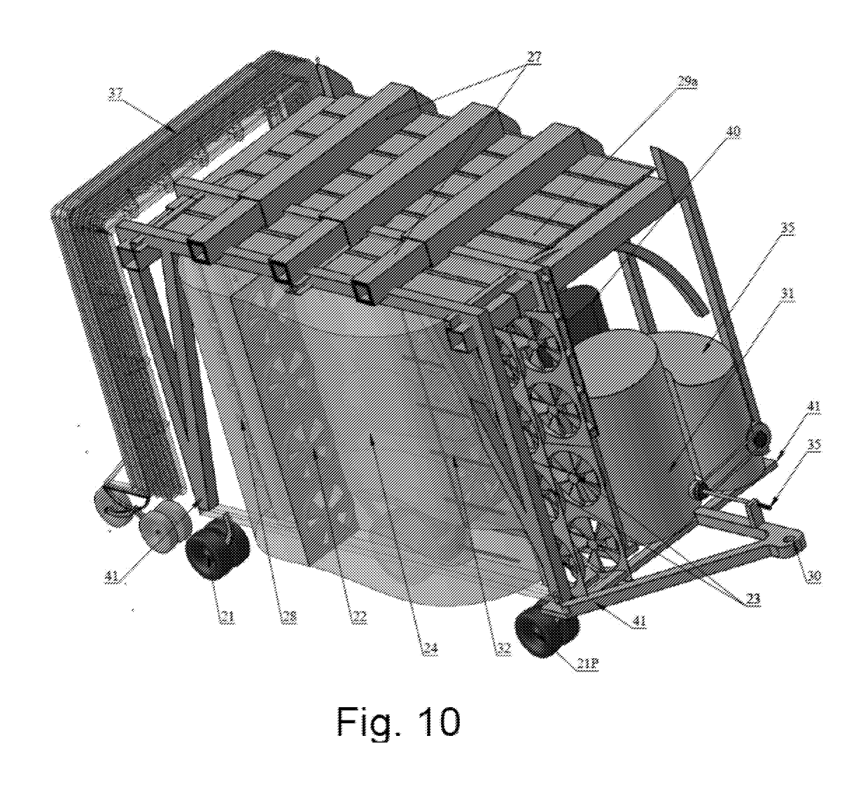

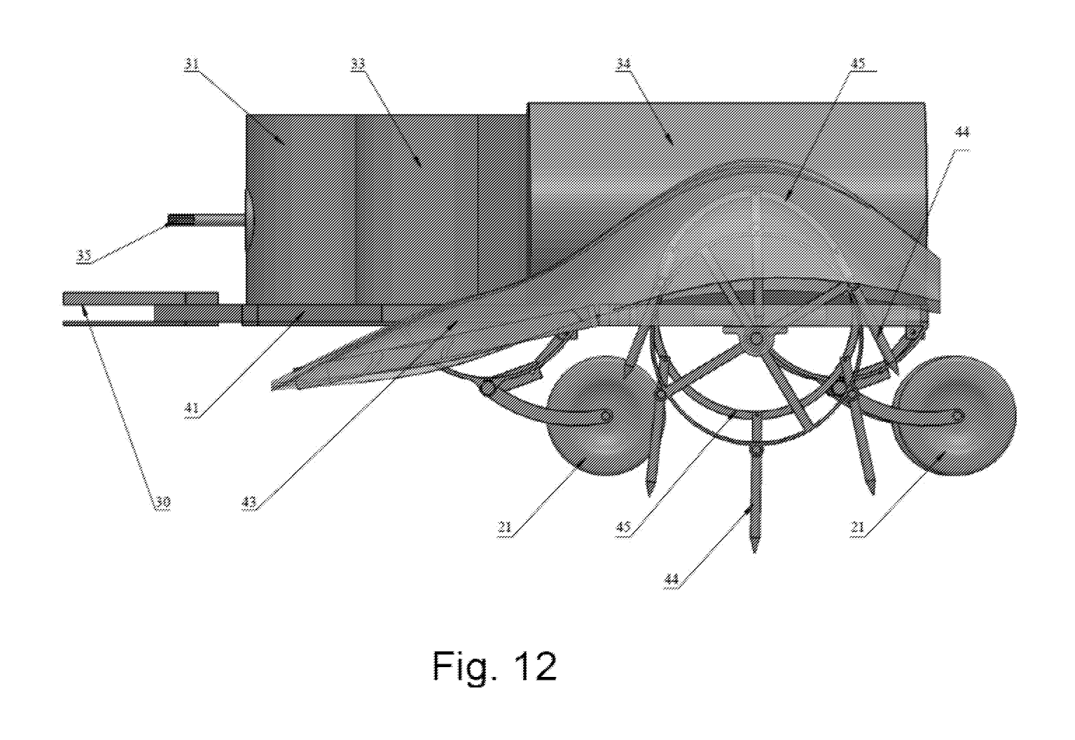

Referring now to the invention, FIGS. 1 to 12, showed more details about component of an “Indiscriminately On-the-GO Tree Heat Treatment Apparatus” and also, for root system heat treatment machine, to perform trees heat treatment. Also, the figures are to have better understanding of the disclosed methods and system.

Indiscriminately On-the-GO Tree Heat Treatment Apparatus, comprising but not limited to;

The structural frame 41, with appropriate size, strength, shape and design, which other component will be mounted on it. The heating chamber 38, in operation mood, is like a tunnel which, surround the trees from top side and two side parallel to the tree's row.

Generally, the front side of the chamber will be covered by wind generated by pre-fans system 23. The pre-fan system placed in front of the apparatus to prevent exit of hot air from the heating chamber 38, during operation.

The structural frame 41, has made of optionally steel or with combination of other suitable material to address appropriate strength, size and shape to be able mount and carries the other components together to perform effective performance

Controlling system perform a level adjusting for the apparatus in ground with slop or inclination to keep the top side of the apparatus always parallel to horizon.

Wheels, with no driven power 21, are designed to carry the weight of the device and other components. Also, some wheel/s can be driven or powered wheels 21P if needed. Driven or powered wheels 21P, can be used to synchronize the direction of the apparatus with tractor or utility vehicle as well.

Extendable telescoping arm/s 27, designed to lengthen and shorten the width of the heating chamber 38. By lengthening and shortening the telescoping arm/s 27, the apparatus can be converted to the operating and transportation mood respectively.

The “Indiscriminately On-the-GO Tree Heat Treatment Apparatus” can be either pulled by a tractor, a utility vehicle, or can be self-propelled device. Pulling hitch point/s 30 is to attach the apparatus to a tractor or utility vehicle.

The upper side of the apparatus heating chamber 38, has an up-down movable face or layer 29a and 29b.

Upper side of the apparatus heating chamber 38, can move to the up higher position 29a, which is for tall trees, although, for the shorter trees the upper side of the apparatus heating chamber 38, can moves down into lower height 29b.

The movement and the height level of upper side of the apparatus heating chamber 38, can adjusted manually or automatically by controller and sensors 36, when it is needed. The controlling system is comprising of; humidity, temperature and air velocity sensor/s and controller/s for adjustment and optimization of mentioned parameters.

In addition to the parameters mentioned above, in order to optimization of the treatment parameters, size variation of the trees, forward speed of apparatus, duration of heat transfer and length of treatment will be monitored and can be adjusted.

The heating chamber 38, can be converted to the transportable mood as the telescoping arms 27, are being shortening.

The extendable tail chamber 37, is an optional part to provide an extendable heating tunnel to maintain duration of heat treatment and heat transfer into tree tissues. To maintain the temperature and adjust the duration of treatment the traveling speed mostly can adjust the duration of time which tree subjected into heat treatment.

Although, for more accuracy and for ease of operator, the extendable tail chamber 37, can do this task automatically to provide steady heat transfer and adjust the duration of heat penetration.

A foldable type tunnel named tail chamber 37, designed to be attached to the back-side of the apparatus and collinear with heating chamber when the apparatus is in operation mood. Tail chamber 37, is foldable in length and can convert to transportation mood along with heating chamber 38.

The extendable tail chamber 37 can be converted to transportation form 37a, when the telescoping arms 27, are being shortening to convert the machine to the transportable mood, extendable tail chamber 37, would already converted into transportation mood 37a, to be assembled as a part of the transportation mood.

The required power for the pumps or other driven parts, for their performance, like; fans or generator can be provided via P.T.O. of tractor to a shaft 35, designed for power transmission. For example, the transmitted power from P.T.O. can be used to run the hydraulic pump system or the electricity generator 31, if hydraulic, electricity or both needed.

Also, the transmitted power can be directly run the steam/heat generator 33, or other components of steam/heat generator if there is need of direct power. The chemical container 40, can be used if there is any chemical needed to be applied.

The water tank 34, with enough capacity is to carry and supply water to steam generator and sprayer system 42. The spray system 42, is to spray a liquid or fume type material, with high specific heat capacity preferably, water, before, till-during heat treatment.

The source of heat is a dual type heater in which, generates dry hot air, steam, and preferably, combination of both. The heating source can be an electrical source or fuel source. The heating source will be used in the heating chamber 38, during operation.

Pre-blower fan/s 23, can be mounted in-front of the heat/steam treatment machine which can be run by hydraulic or electrical motor. Pre-blower fan/s 23, are to induce the tree canopy into high velocity of air flow or wind just before heat treatment get started. Though, the pre-blower fan/s 23, can be used to help penetration of the sprayed water into canopy middle.

Boom spray system 42, with series of nuzzle is mounted to spray water, with, or without chemical solution if needed. Moreover, the pre-spray water with moderate temperature, prevents tree shock during the heat treatment.

Spray a liquid like water with higher specific heat capacity increases the specific heat capacity of tree canopy. Therefore, heat can transfer into tree endodermis in longer duration.

Spray system is to increase the specific heat capacity of tree canopy and protect tree of overheat and also, increase the tree tolerance when it is subjected to the heat or steam. Moreover, the water spray can shut off the stomata's in leaves and reduce transpiration.

The air circulation system is to circulate hot/humid/air comprising air circulation chamber/s 24, and consequently results hot/humid/air circulation in heating chamber 38, consistently, with appropriate air velocity. Air circulation, results uniformity of parameters like humidity and temperature during treatment.

Air circulation pattern, in the circulation system can be in horizontal, perpendicular or angular plane or combination of them. Although, a combination of mentioned circulation patterns can be used to circulate hot/humid/air in heating chamber 38.

The air circulator chamber 24, comprising; blower receiver 24a, and blower outlet 24b, and fan/s 22, placed in air circulator chamber 24, can circulate the hot/steamed or humid air.

The series of steam nozzles 28, can inject the steam into air circulation flow, preferably, mounted at the outlet of the blower trapdoor 24b. Moreover, air circulator chamber 24, and fan/s 22 can circulate and blow out the steam or hot humid air which results air circulation.

In different position/place of heating chamber 38, series of sensors 32, can sense the moisture, temperature, and the air velocity to be able to control these parameters in the air circulation system. The combination of the air circulator chamber 24, right and left side of heating chamber 38, results air circulation, uniformity homogeneity of the flowed material by air.

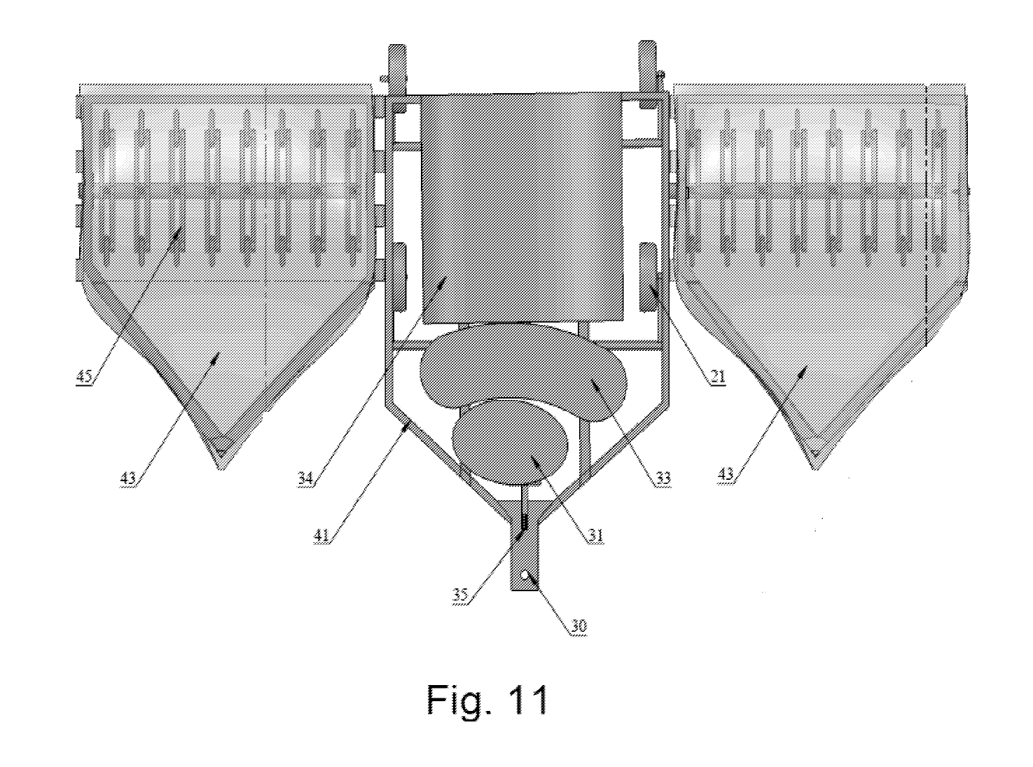

Optionally, efficient steam injection system for tree root system, can be used as an attachment to the “Indiscriminately On-the-GO Tree Heat Treatment Apparatus”, or as a pull behind steam injector machine/apparatus, FIG. 11.

The efficient steam injector can be used to inject steam into soil. Optionally, some chemical can be added into steam or circulation flow, if needed. Steam injector machine/apparatus used for heat treatment operation comprising but not limited to; injector finger 44, kinematic pathway system and attachment 45, to control and adjust the attack angle and the injector outcome angle from the soil.

Divider shield 43, is to lift the lower tree branches to make enough room for the injector device to move underneath of the tree canopy. The carrying wheels 21, are to carry the device and also, control the depth of treatment.

The required power for the pump/s or other parts, which need power for their performance, like; injectors finger 44, or generator can be provided via P.T.O. of tractor to a shaft 35, designed for power transmission.

To increase the accuracy of the treatment duration, heat transfer rate, and for ease of operator, the extendable tail chamber 37, can be extended automatically to provide steady heat and adjust the duration of effective treatment.

The extendable tail chamber 37, can be converted to transportation form 37a. When the telescoping arms 27, are being shortening to convert the machine to the transportable mood, extendable tail chamber 37, would already converted into transportation mood 37a, to be assembled as a part of the transportation mood.

The heat treatment duration, is related to forward speed of device, level of humidity and also the length of adjustable tail chamber of tree heat treatment machine. Using a high specific heat capacity as liquid spray preferably water, before and ahead of heating chamber 38, maintain the level of heat transfer rate during operation.

The risk of heat treatment operation by an accurate heat transfer rate control and optimization of the related parameters during heat treatment will be reduced.

Increase the uniformity and fast penetration of heat into the canopy by using air circulator system 24, which can be make air circulation horizontally, perpendicular or in angular circulation plane.

The air circulation pattern, can be in combination pattern of horizontally, perpendicular or angular air circulation plane, which helps to maintain the uniformity of humidity and temperature and also, air velocity.

Additionally, ability of maintaining the uniformity of temperature and humidity level of the heating chamber 38, during operation will reduce the time of operation and increase quality, performance and also, efficiency of heat treatment.

The material in-used in the methods for construction or manufacturing of the current invention consider to be the suitable material, for example, heat-conductive material will be used when heat transfer is required, which non-heat-conductive material generally will be consider to be used outside of the apparatus and also, when heat transfer should be prevented.

Meanwhile of using the methods and apparatus to control diseases, it is contemplated to use tree quarantine belt as a quarantine health gate, before treatment to disconnect and prevent pathogen movement/transfer from the upper part of tree to the lower part and the root system. Also, the root heat treatment device can be attached to an on-the-go tree heat treatment apparatus.

It should be noted this treatment and working with heat or steam maker may cause damage and serious injury or death. The user should be aware of the risk of operation on his/her own, and should follow all necessary rolls and protection which if ignored, could result in death or serious personal injury caused by incorrect operation of equipment.

Invertor specifically disclaims any implied warranty of non-infringement or merchantability or fitness for a particular purpose and will in no event be liable for any indirect, consequential, incidental, special or aggravated or other similar or like damages or losses, including any loss of profits, arising from any defect, error or failure to perform, even if it has been advised of the possibility of such damages or losses.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

### SUMMARY

The present invention relates to “Indiscriminately On-the-GO Tree Heat Treatment Apparatus and Effective Methods”, comprising but not limited to; structural design, heating system, controlling system, system to reduce transpiration, system and method to maintain the uniformity of temperature and humidity, method to control the heat transfer rate into trees tissue and system to maintain the heat transfer duration. By attaching the roots heat treatment machine to the efficient tree heat treatment apparatus, all the canopy and the system be covered by heat treatment in one pass, although, it is possible to use these two device separately. The heat-steam treatment can be used in combination with other plant diseases control method/s like combination with high voltage electricity treatment to reduce the usage of chemicals.

### ADVANTAGES

Environmentally friendly, eliminating need for harmful chemicals, Machine/s would be easily designed and portable, lowering costs and increasing ease of treatments,

Increase the uniformity and faster penetration into tree canopy middle

Reduce the energy consumption by targeting the tree canopy

Reduce the time of operation and increase the quality of the treatment

Reduce the water intake, which results higher efficiency

### REFERENCE

Non-destructive heat treatment of trees to stop disease progression patented, by; Lammeren Andreas Antonius Maria Van, et, al. 2014, patent No.: WO2014001476 A3

Tunnel sprayer for rows of plants, by; Sergio Bertoni. 2008, U.S. Pat. No. 11/554,618

Methods and Systems for High Voltage Treatment of Soil and Plant, by; Ali Mirzakhani Nafchi 2014, U.S. application Ser. No. 14/876,834.

Lin et al. 1964 reported eliminating yellow shoot disease by water-saturated hot air treatment of graft wood at 48-58° C. with no loss of tissue viability.

Cheema et al. 1982, reported treatment of budwood at 47° C. for 2 h reduced disease incidence and longer treatments eliminated the pathogen.

Lo et al. 1981, further proved that diseased budlings recovered normal growth after moist air treatment for 50 min at 49° C. or 50° C. Lo 1983, reported that budwoods collected from diseased tree could be sterilized by immersing in 47° C. water for 10 min and repeat twice with the interval of 24 hours.

1. Indiscriminately On-the-GO Tree Heat Treatment Apparatus and its Effective Methods, is disclosing, comprising; but not limited to; structural design , heating system, controlling system, system to reduce transpiration, system and method to maintain the uniformity of temperature and humidity, method to control the heat transfer rate to tree tissue and system to maintain the heat transfer duration. System to reduce transpiration according to claim 1, wherein said “reduce transpiration” is comprising; a system to close, or partially close the tree leaves stomata to reduce transpiration ‘before/during/after’ the heat treatment operation. Method to maintain the heat transfer rate into the tree tissue according to claim 1, wherein said “heat transfer rate” is comprising; a method to maintain the gradually and constantly heat transfer, maintain and optimization of heat transfer rate from observed heat by epidermis into the tree canopy endodermis. Controlling system, according to claim 1, is comprising; sensor/s and controller/s of humidity, temperature and air velocity for adjustment and optimization of mentioned parameters. In addition to the parameters mentioned above, in order to optimization of the treatment parameters, the variation in size of the trees, forward speed of apparatus, duration of heat transfer and length of treatment will be monitored. The controlling system may be manually or automatically. System to reduce transpiration according to claim 2, wherein said “close or partially close the tree leaves stomata”, can be accomplished by using one or combination of some of techniques mentioned below as; sub-system/s comprising;
i. Inducing the tree canopy into high velocity air flow or wind just before the heat treatment which constantly shifts into the heat treatment operation while the machine moving forward.
ii. Stimulation with high voltage low amperage pulses, at least for short time to shake the disease's chemical bonds in tree canopy which can cause stomata closing and loosening the bond of diseases.
iii. Using chemical for leaves fall spray to close the leaves stomata to reduce transpiration for appropriate period, before, till-after heat treatment.
iv. In an exigent condition, depend on the season, time permit and disease infection level alternate method can be combination of some of above methods together. The method/s to maintain the gradually and constantly heat transfer into trees tissue according to claim 3, wherein said “maintain and optimization of heat transfer rate”, is comprising; a spray system to spray a liquid or fume type material, with high specific heat capacity preferably, water or mix, before, till-during heat treatment. Meanwhile, the level and uniformity of temperature and humidity during heat treatment operation in heat chamber will be controlled. To maintain and optimization of heat transfer rate from observed heat by epidermis to the tree canopy endodermis, according to claim 3, wherein said “spray a liquid”, is comprising; a liquid or fume type material with high specific heat capacity preferably water, to spray on tree canopy before, till-during heat treatment to observe/hold heat, and gradually, consistently and uniformly transfer it into tree tissue. Moreover, the pre-spray with moderate temperature of the mentioned liquid prevent tree shock by facing high level of temperature. Also, a layer of sprayed material like fume or other type of harmless chemical with higher specific heat capacity increases the specific heat capacity of tree canopy, therefore, heat can transfer into tree endodermis, in longer duration which, results smooth and slow decrease in temperature after passing the heat chamber, and the tail-chamber, as the apparatus travels forward. The system/s to maintain the temperature uniformity according to claim 1, wherein said “maintain the uniformity of temperature and humidity”, is comprising; air circulation system to circulate hot/humid/air in air heating chamber, consistently, with appropriate air velocity. The air circulation system according to claim 9, wherein said “a system to circulate hot/humid/air” is comprising; at least an air circulation chamber, preferably, both side of heating chamber, including one or series of fan/s which cause the air circulation inside of heating chamber, constantly. Air circulation pattern, in the circulation system can be in the horizontal, perpendicular or angular plane. Although, a combination of mentioned circulation patterns can be used to circulate hot/humid/air inside of heating chamber. The source of heat according to claim 1, wherein said “heating system” is comprising; any type of heating source, which, be able to generate dry hot air, or steam preferably, combination of both. The heating source can be an electrical source or fuel source. The heating source will be used in the heating chamber during operation. The controlling system according to claim 4, wherein said “controller/s” is comprising; controller/s to control and adjust the fan/s speed to regulate air velocity in appropriate level, controller/s to control and adjust heating source which results temperature adjustment and controller/s to optimize the humidity. In order to regulate the level of humidity in the heating chamber, if level of humidity is higher than desire level, thereafter, the dry heating source will be used and the amount of water spray that causes higher humidity will be reduced, meanwhile, if the humidity is lower than desire level the steam source will be used to have optimized level of temperature, humidity and uniformity of these parameters in the heating chamber during operation. The apparatus for efficient tree heat treatment according to claim 1, wherein said “structural design” is comprising but not limited to; The frame with appropriate size, strength, and shape designed to perform the heat treatment and other component will be mounted on. The heating chamber in operation mood, is like a tunnel which, surround trees from top side and two side of the parallel to the tree's row. Also, a shield cover can be placed underneath of tree branches to prevent wastage of heat into soil. Hypothetically, the front side of the heating chamber will be covered by wind generated by fans in front of the apparatus which prevents hot air exit from the heating chamber during operation. Tail chamber as a foldable type tunnel, designed to be attached to the back-side of the apparatus and collinear with heating chamber when the apparatus is in operation mood. Tail chamber is foldable in length and can convert to transportation mood along with heating chamber. The tunnel foldable type tail chamber, preferably, made of flexible shield, with at least one ‘∩’ shape frame at the back-end of tunnel. The shield can be supported by cables connected from heating chamber to the ‘∩’ shape frame. To fold the tail chamber support cables pull the ‘∩’ frame and the shield will fold due to cable shortening. The ‘∩’ shape frame equipped with wheels to help for unfolding and increase the stability of the frame with shield, which easily can follow the trees row and the heating chamber. The tail chamber designed to be attached to the back-end of the apparatus and also, the length of tail chamber can be adjusted during operation by control the length of the cables. System to reduce transpiration according to claim 5 section I, wherein said “system to reduce transpiration using high velocity air flow or wind”, is comprising; the fan/s to generate high velocity air flow or wind in front of the heating chamber. The position of the above mentioned fans system helps to coverage all canopy and also, prevents hot/humid air exit-out from the heating chamber.
